(19) United States
(12) Patent Application Publication
(10) Pub. No.: US 2024/0031925 A1
(43) Pub. Date: Jan. 25, 2024

(54) METHOD OF AMF, METHOD OF UE, AMF, AND UE

(71) Applicant: NEC Corporation, Minato-ku, Tokyo (JP)

(72) Inventors: Kundan TIWARI, Tokyo (JP); Toshiyuki Tamura, Tokyo (JP)

(73) Assignee: NEC Corporation, Minato-ku, Tokyo (JP)

(21) Appl. No.: 18/027,065

(22) PCT Filed: Sep. 30, 2021
(86) PCT No.: PCT/JP2021/036064

§ 371 Date: Mar. 17, 2023

(30) Foreign Application Priority Data
Oct. 1, 2020 (IN) 202011042823

(51) Int. Cl. H04W 48/18; H04W 48/16; H04W 60/00

(52) U.S. Cl. CPC H04W 48/18; H04W 48/16; H04W 60/00

(57) ABSTRACT

A method performed by Access and Mobility Management Function, AMF (800) for handling of network slice specific authentication and authorization procedure, is disclosed. In an embodiment, a network shall restart a generic UE configuration update procedure when the network encounters radio link failure before completion of the ongoing generic UE configuration update procedure. In another embodiment, the network sends CONFIGURATION UPDATE COMMAND message containing the Allowed NSSAI when a N1 NAS signaling connection is established after the radio link failure.

### TECHNICAL FIELD

The present disclosure relates generally to wireless telecommunications, and, in particular embodiments, relates to handling of slice authentication and authorization procedure.

### BACKGROUND ART

A serving PLMN shall perform Network Slice-Specific Authentication and Authorization, hereinafter referred to as an “NSSAA”, for the S-NSSAIs of the HPLMN which are subject to it based on subscription information for example, during the registration procedure when a REGISTRATION REQUEST message contains Requested NSSAI including an S-NSSAI subject to the NSSAA. The UE shall indicate in the REGISTRATION REQUEST message in the UE 5GMM Core Network Capability whether it supports the NSSAA feature. If the UE does not support the NSSAA feature and if the UE requests any of these S-NSSAIs that are subject to NSSAA, the AMF shall not trigger the NSSAA procedure for the UE and those of requested S-NSSAIs that are subject to NSSAA procedure are rejected by the PLMN. To perform the NSSAA for an S-NSSAI, the AMF invokes an EAP-based NSSAA procedure for the S-NSSAI. When the NSSAA procedure is started and is ongoing for an S-NSSAI, the AMF stores the NSSAA status of the S-NSSAI as pending and when the NSSAA procedure is completed the S-NSSAI becomes either part of the Allowed NSSAI or a Rejected S-NSSAI depending on a result of the NSSAA procedure. The NSSAA status of each S-NSSAI, if any is stored, and is transferred when the AMF changes. The example processes related to the NSSAA procedure are shown in FIG. 1.

### CITATION LIST

### Non Patent Literature

NPL 1: 3GPP TR 21.905: “Vocabulary for 3GPP Specifications”. V16.0.0 (2019-06)
NPL 2: 3GPP TS 23.501: “System architecture for the 5G System (5GS)”. V16.5.1 (2020-08)
NPL 3: 3GPP TS 23.502: “Procedures for the 5G System (5GS)”. V16.5.1 (2020-08)
NPL 4: 3GPP TS 24.501: “Non-Access-Stratum (NAS) protocol for 5G System (5GS); Stage 3”. V16.5.1 (2020-07)

### SUMMARY OF INVENTION

### Technical Problem

When the radio link failure happens, before completion of the generic UE configuration update procedure, a status of the S-NSSAI in the UE and a status of the S-NSSAI in network side may mismatch and not synchronize each other, and this will lead to loss of service related to the S-NSSAI for the user.

### Solution to Problem

In a first aspect of the present disclosure, a method of an Access and Mobility Management Function (AMF), is provided, and the method comprises: sending a CONFIGURATION UPDATE COMMAND message, wherein the CONFIGURATION UPDATE COMMAND message includes Allowed Network Slice Selection Assistance Information (NSSAI) or Rejected NSSAI; starting a timer the CONFIGURATION UPDATE COMMAND message is sent; and retransmitting the CONFIGURATION UPDATE COMMAND message on expiry of the timer in a case where failure related to a radio link is detected before a CONFIGURATION UPDATE COMPLETE message is received.

In a second aspect of the present disclosure, a method of a User Equipment (UE) is provided, and the method comprises: communicating with an Access and Mobility Management Function (AMF); and initiating a Registration procedure in a case where radio coverage is lost and the UE has Single Network Slice Selection Assistance Information (NSSAI) in Pending NSSAI.

In a third aspect of the present disclosure, an Access and Mobility Management Function (AMF) comprises: means for sending a CONFIGURATION UPDATE COMMAND message, wherein the CONFIGURATION UPDATE COMMAND message includes Allowed Network Slice Selection Assistance Information (NSSAI) or Rejected NSSAI; means for starting a timer the CONFIGURATION UPDATE COMMAND message is sent; and means for retransmitting the CONFIGURATION UPDATE COMMAND message on expiry of the timer in a case where failure related to a radio link is detected before a CONFIGURATION UPDATE COMPLETE message is received.

In a fourth aspect of the present disclosure, a User Equipment (UE) comprises: means for communicating with an Access and Mobility Management Function (AMF); and means for initiating a Registration procedure in a case where radio coverage is lost and the UE has Single Network Slice Selection Assistance Information (NSSAI) in Pending NSSAI.

### BRIEF DESCRIPTION OF DRAWINGS

FIG. 1 illustrates a conventional network slice specific authentication and authorization procedure.

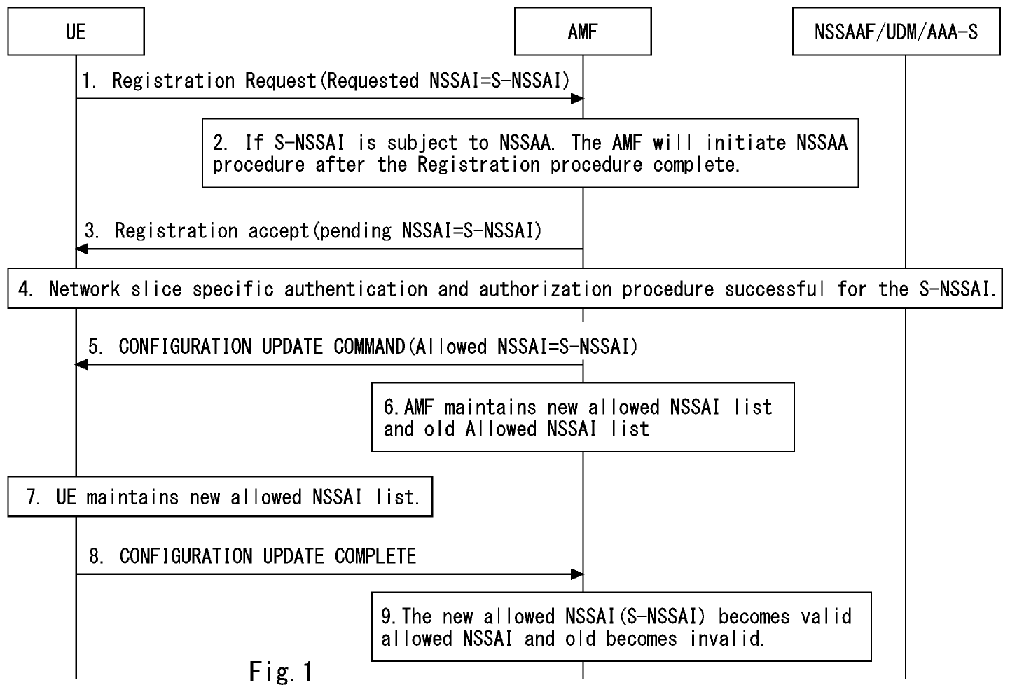

FIG. 2 is a signaling diagram illustrating an embodiment of restarting a generic UE configuration update procedure.

FIG. 3 is a signaling diagram illustrating an embodiment of sending CONFIGURATION UPDATE COMMAND message containing the Allowed NSSAI when a N1 NAS signaling connection is established after a radio link failure.

FIG. 4 is a signaling diagram illustrating an embodiment of PDU session establishment procedure.

FIG. 5 is a signaling diagram illustrating an embodiment of registration procedure by UE.

FIG. 6 is a block diagram schematically illustrating UE.

FIG. 7 is a block diagram schematically illustrating RAN node.

FIG. 8 is a block diagram schematically illustrating AMF.

### DESCRIPTION OF EMBODIMENTS

The present disclosure provides an improved system and method of handling of slice authentication and authorization procedure. More specifically, the disclosure relates to a method to transmit Allowed NSSAI to the UE in weak radio coverage during the network specific slice authentication and authorization procedure.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope.

The disclosure will be described and explained with additional specificity and detail with the appended figures.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the embodiments disclosed herein in addition to, or instead of, a system, and all such embodiments are contemplated as within the scope of the present disclosure.

### Example 1 of Problem Statement

When the network receives an S-NSSAI subject to the NSSAA in Requested NSSAI during a NAS procedure (e.g. Registration Procedure), the network will execute the NSSAA procedure. After the execution of the NSSAA procedure the network will transmit to the UE an outcome of NSSAA procedure for the S-NSSAI. If the NSSAA procedure is successful, the network will put the S-NSSAI in the Allowed NSSAI otherwise put the S-NSSAI in the Rejected NSSAI. Then the AMF initiates generic UE configuration update procedure to transmit at least one of this Allowed NSSAI and Rejected NSSAI (either new Allowed NSSAI or Rejected NSSAI, or both new Allowed NSSAI and Rejected NSSAI) to the UE in a CONFIGURATION UPDATE COMMAND message. When the radio link failure happens before completion of the generic UE configuration update procedure, then the UE may not receive the Allowed NSSAI from the network. Hence a status of the S-NSSAI in the UE and a status of the S-NSSAI in network side may mismatch and not synchronize each other, this will lead to loss of service related to the S-NSSAI for the user.

### Example 2 of Problem Statement

When the network receives an S-NSSAI subject to the NSSAA in a requested NSSAI during a NAS procedure (e.g. Registration Procedure), the network will execute the NSSAA procedure. After the execution of the NSSAA procedure the network will transmit to the UE an outcome of NSSAA procedure for the S-NSSAI. If the NSSAA procedure is successful, the network will put the S-NSSAI in the Allowed NSSAI otherwise put the S-NSSAI in the Rejected NSSAI. The network maintains a new Allowed NSSAI and an old Allowed NSSAI and initiates generic UE configuration update procedure to transmit at least one of new Allowed NSSAI and Rejected NSSAI (either new Allowed NSSAI or Rejected NSSAI, or both new Allowed NSSAI and Rejected NSSAI) to the UE in the CONFIGURATION UPDATE COMMAND message. Upon reception of a CONFIGURATION UPDATE COMPLETE message from the UE, the network deletes the old Allowed NSSAI and maintains the new Allowed NSSAI. Difference between the new Allowed NSSAI and the old Allowed NSSAI is whether the S-NSSAI subject to the NSSAA is included. That is, the new Allowed NSSAI includes at least one S-NSSAI including the S-NSSAI subject to the NSSAA. The old Allowed NSSAI includes at least one S-NSSAI, however does not include the S-NSSAI subject to the NSSAA.

When the radio link failure happens before completion of the generic UE configuration update procedure, the network will abort the generic UE configuration update procedure. In this scenario, if the network does not receive the CONFIGURATION UPDATE COMPLETE message from the UE then the network maintains two Allowed NSSAI lists i.e. new Allowed NSSAI and old Allowed NSSAI. When the network receives a 5G Session Management message (for example, a PDU session establishment request message) containing the S-NSSAI in the new Allowed NSSAI, then the network behavior is not clear whether the network will execute the PDU Session Establishment procedure or reject it.

This disclosure describes the solutions to an issue where S-NSSAI status mismatch between the UE and the Network happens. The mismatch may happen due to a radio link failure or any other reason.

All procedures disclosed in each embodiment can apply to S-NSSAI status management between the UE and the Network for the 3GPP Access as well as for the non-3GPP Access. All procedures disclosed in each embodiment can apply to S-NSSAI status management between the UE and the Network for the PLMN as well Stand-alone non-public networks and Public Network Integrated NPN as described in the section 5.30.2 and 5.30.3 respectively in 3GPP TS 23.501 [2].

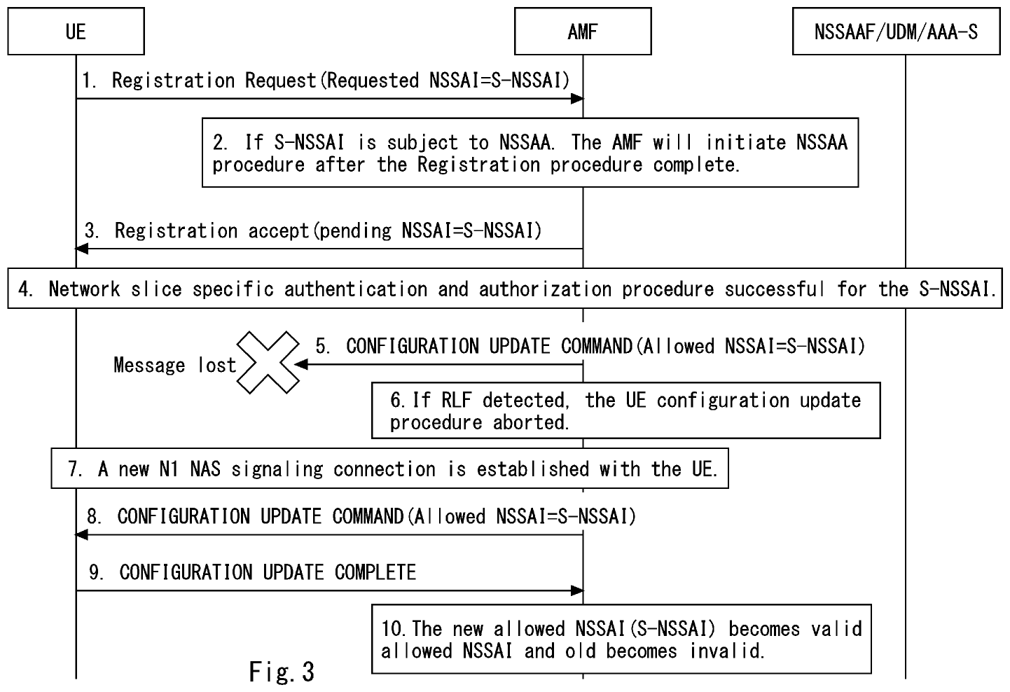

In some embodiments, it is disclosed that the generic UE configuration update procedure takes place after the AMF detects radio link failure. For example, step 8 and step 9 in FIG. 3 of the embodiment 2. If the Registration procedure takes place after the radio link failure, the Registration procedure can take over what the generic UE configuration update procedure intends to do. The Registration procedure can be an initial registration procedure, a registration procedure due to mobility or a periodic registration procedure. For example, the Allowed NSSAI which is to be sent in the CONFIGURATION UPDATE COMMAND message is sent in a REGISTRATION ACCEPT message. In this case, following replacements of message name apply to all embodiments.
(1) The CONFIGURATION UPDATE COMMAND message is replaced by the REGISTRATION ACCEPT message.
(2) The CONFIGURATION UPDATE COMPLETE message is replaced by a REGISTRATION COMPLETE message.

### First Example Embodiment (Solution 1)

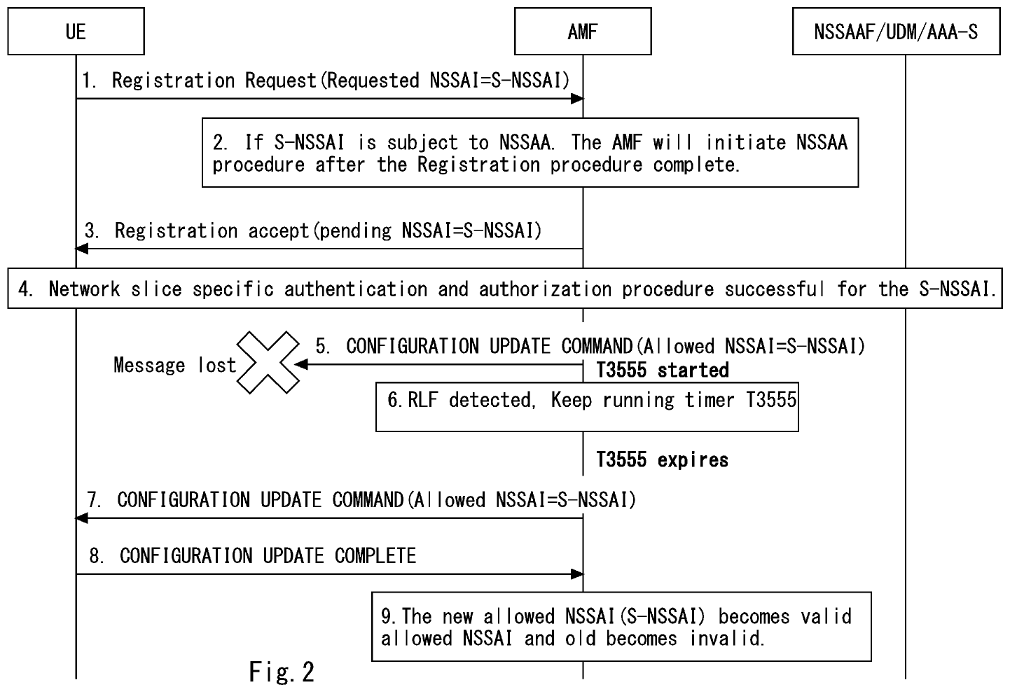

As shown in FIG. 2, the network shall restart a generic UE configuration update procedure when the network encounters radio link failure before completion of the ongoing generic UE configuration update procedure.

The details of this solution are mentioned below.

1. A UE sends, to an AMF, a REGISTRATION REQUEST message containing Requested NSSAI which includes at least one S-NSSAI.

2. When the AMF receives the REGISTRATION REQUEST message from the UE, the AMF determines whether the S-NSSAI included in the Requested NSSAI is subject to NSSAA or not by referring the subscriber data of the UE that is obtained from a UDM using the Nudm_SDM_Get service.

If the S-NSSAI is subject to NSSAA procedure, the AMF marks the S-NSSAI as pending.

3. The AMF, to the UE, sends a REGISTRATION ACCEPT message containing Pending NSSAI including the S-NSSAI.

4. The AMF initiates the NSSAA procedure for the S-NSSAI as described in the section 4.2.9 in 3GPP TS 23.502 [3]. This step 4 refers to only EAP based Network Slice-Specific Authentication and Authorization for S-NSSAI. The UE Configuration Update procedure that may execute after the EAP based Network Slice-Specific Authentication and Authorization is described in step 5 and later.

5. After the successful completion of the NSSAA procedure for the S-NSSAI, the AMF initiates generic UE configuration update procedure by sending a CONFIGURATION UPDATE COMMAND message containing Allowed NSSAI including the S-NSSAI. The AMF starts a retry timer (e.g. T3555) at the same time when the AMF sends the CONFIGURATION UPDATE COMMAND message or after the AMF sends the CONFIGURATION UPDATE COMMAND message.

The AMF also starts the retry timer when the NSSAA procedure fails and the AMF sends the CONFIGURATION UPDATE COMMAND message containing Rejected NSSAI including the S-NSSAI. That is, a cause of start of the retry timer is a transmission of the CONFIGURATION UPDATE COMMAND message. The Allowed NSSAI is a list of at least one of S-NSSAI. The Rejected NSSAI is a list of at least one of S-NSSAI.

6. When the AMF detects a radio link failure happened (e.g. the NG-RAN indicates to the AMF the UE radio contact is lost through a NGAP message), the AMF does not abort the generic UE configuration update procedure, i.e. the AMF keeps running the retry timer.

7. When the retry timer expires, the AMF retransmits the CONFIGURATION UPDATE COMMAND message containing the Allowed NSSAI including the S-NSSAI or Rejected NSSAI including the S-NSSAI.

8. When the UE receives the CONFIGURATION UPDATE COMMAND message, the UE updates a status of S-NSSAI and transmits a CONFIGURATION UPDATE COMPLETE message to the AMF.

9. When the AMF receives the CONFIGURATION UPDATE COMPLETE message from the UE, the AMF updates a status of S-NSSAI as valid and updates the S-NSSAI status as allowed S-NSSAI if the CONFIGURATION UPDATE COMMAND message in step 7 contains the S-NSSAI in the Allowed NSSAI. That is, the S-NSSAI becomes part of the Allowed NSSAI.

If the CONFIGURATION UPDATE COMMAND message in step 7 contains the S-NSSAI in the Rejected NSSAI, the AMF updates a status of the S-NSSAI as Rejected S-NSSAI. That is, the S-NSSAI becomes part of the Rejected NSSAI. The AMF may maintain an associated information to the rejected S-NSSAI as this S-NSSAI has failed the NSSAA.

Variant of Solution 1:

In an embodiment, the AMF includes a 5G-GUTI (for example, a new 5G-GUTI or current 5G-GUTI) in the CONFIGURATION UPDATE COMMAND message in step 5 and step 7 together with the Allowed NSSAI or the Rejected NSSAI. Upon detecting the radio link failure in step 6, the AMF keeps running the retry timer. When the retry timer expires the AMF retransmits CONFIGURATION UPDATE COMMAND message.

In an embodiment, the above embodiments are also applicable for the scenario when the CONFIGURATION UPDATE COMMAND message contains other information element (e.g. Configured NSSAI, allowed CAG information) in the generic UE CONFIGURATION UPDATE procedure.

### Second Example Embodiment (Solution 2)

As shown in FIG. 3, the network sends a CONFIGURATION UPDATE COMMAND message containing the Allowed NSSAI when a N1 NAS signaling connection is established after the radio link failure.

The details of this solution are mentioned below.

1. A UE sends, to an AMF, a REGISTRATION REQUEST message containing Requested NSSAI which includes at least one S-NSSAI.

2. When the AMF receives the REGISTRATION REQUEST message from the UE, the AMF determines whether the S-NSSAI included in the Requested NSSAI is subject to NSSAA or not by referring the subscriber data of the UE that is obtained from a UDM using the Nudm_SDM_Get service. If the S-NSSAI is subject to NSSAA procedure, the AMF marks the S-NSSAI as pending.

3. The AMF sends, to the UE, a REGISTRATION ACCEPT message containing Pending NSSAI including the S-NSSAI.

4. The AMF initiates the NSSAA procedure for the S-NSSAI as described in the section 4.2.9 in 3GPP TS 23.502 [3]. This step 4 refers to only EAP based Network Slice-Specific Authentication and Authorization for S-NSSAI. The UE Configuration Update procedure that may execute after the EAP based Network Slice-Specific Authentication and Authorization is described in step 5 and later.

5. After the successful completion of the NSSAA procedure for the S-NSSAI, the AMF initiates generic UE configuration update procedure by sending a CONFIGURATION UPDATE COMMAND message containing Allowed NSSAI including the S-NSSAI. The AMF may start a retry timer (e.g. T3555) at the same time when the AMF sends the CONFIGURATION UPDATE COMMAND message or after the AMF sends the CONFIGURATION UPDATE COMMAND message.

The AMF also may start the retry timer when the NSSAA procedure fails and the AMF sends the CONFIGURATION UPDATE COMMAND message containing Rejected NSSAI including the S-NSSAI. That is, a cause of start of the retry timer is a transmission of the CONFIGURATION UPDATE COMMAND message.

6. When the AMF detects a radio link failure happened (e.g. the NG-RAN indicates to the AMF the UE radio contact is lost through a NGAP message), the AMF aborts the generic UE configuration update procedure and the retry timer is stopped if running.

The AMF sets the UE status “UCU (UE Configuration Update) needed” in the UE MM context or local memory in the AMF together with the message contents of the CONFIGURATION UPDATE COMMAND message that was sent in step 5. The UE status “UCU needed” implies that the generic UE configuration update procedure needs to take place for the UE as an S-NSSAI status between the UE and the network might be mismatched.

Alternately, the AMF sets the S-NSSAI status as “Unsynchronized” in the UE MM context or local memory in the AMF. The S-NSSAI status “Unsynchronized” implies that the generic UE configuration update procedure needs to take place for this S-NSSAI as an S-NSSAI status between the UE and the network might be mismatched.

For example, the AMF maintains or stores information indicating at least one of the UE status as “UCU needed” and the S-NSSAI status as “Unsynchronized”.

If the AMF relocation is executed while AMF maintains at least one of the UE status “UCU needed” and the S-NSSAI status “Unsynchronized”, at least one of the UE status “UCU needed” (together with associated information) and the S-NSSAI status “Unsynchronized” needs to be transferred from the old AMF to new AMF using the Namf_Communication_UEContextTransfer service as described in the section 5.2.2.2.2 in 3GPP TS 23.502 [3].

7. A new N1 NAS signaling connection is established with the UE. For example, when the UE returns back to a 3GPP coverage and sends the REGISTRATION REQUEST message to the AMF. The new N1 NAS signaling connection is established by a Registration procedure which includes sending the REGISTRATION REQUEST message.

8. If the AMF manages (or stores) the UE status as “UCU needed” or the S-NSSAI status as “Unsynchronized”, the AMF retransmits the CONFIGURATION UPDATE COMMAND message containing the Allowed NSSAI including the S-NSSAI or Rejected NSSAI including the S-NSSAI. When the UE receives the CONFIGURATION UPDATE COMMAND message, the UE updates a status of S-NSSAI.

9. The UE sends a CONFIGURATION UPDATE COMPLETE message to the AMF.

10. When the AMF receives the CONFIGURATION UPDATE COMPLETE message from the UE, the AMF updates a status of S-NSSAI as valid and updates the S-NSSAI status as allowed S-NSSAI if the CONFIGURATION UPDATE COMMAND message in step 8 contains the S-NSSAI in the Allowed NSSAI. That is, the S-NSSAI becomes part of the Allowed NSSAI.

If the CONFIGURATION UPDATE COMMAND message in step 8 contains the Rejected NSSAI, the AMF updates a status of S-NSSAI as Rejected S-NSSAI. That is, the S-NSSAI becomes part of the Rejected NSSAI. The AMF may maintain an associated information to the rejected S-NSSAI as this S-NSSAI has failed the NSSAA.

Variant to the Solution 2:

In an embodiment, when the new N1 NAS signaling connection is established with the UE in step 7 and the AMF maintains the S-NSSAI status as “Unsynchronized”, then the AMF may initiate the NSSAA procedure for the S-NSSAI. Then the AMF transmits the Allowed NSSAI including the S-NSSAI to the UE using Generic UE configuration update procedure if the NSSAA procedure is successfully completed. After the NSSAA procedure is successfully completed, the AMF may delete or reset the UE status “UCU needed” or the S-NSSAI status “Unsynchronized”.

In another embodiment, if the AMF receives the REGISTRATION REQUEST message in step 7 as a new N1 NAS signaling connection and the AMF maintains the S-NSSAI status as “Unsynchronized”, then the AMF may send, to the UE, the REGISTRATION ACCEPT message containing the Allowed NSSAI which includes the S-NSSAI, instead of initiating the Generic UE configuration update procedure. The AMF shall maintain the new Allowed NSSAI which is marked as invalid and old Allowed NSSAI which is marked as valid or just the new Allowed NSSAI. When the UE receives the REGISTRATION ACCEPT message with “Allowed NSSAI”, the UE shall send a REGISTRATION COMPLETE message to acknowledge the reception of the latest Allowed NSSAI. When the AMF receives the REGISTRATION COMPLETE message then the AMF shall mark the new allowed NSSAI as valid and old Allowed NSSAI as invalid.

### Third Example Embodiment (Solution 3)

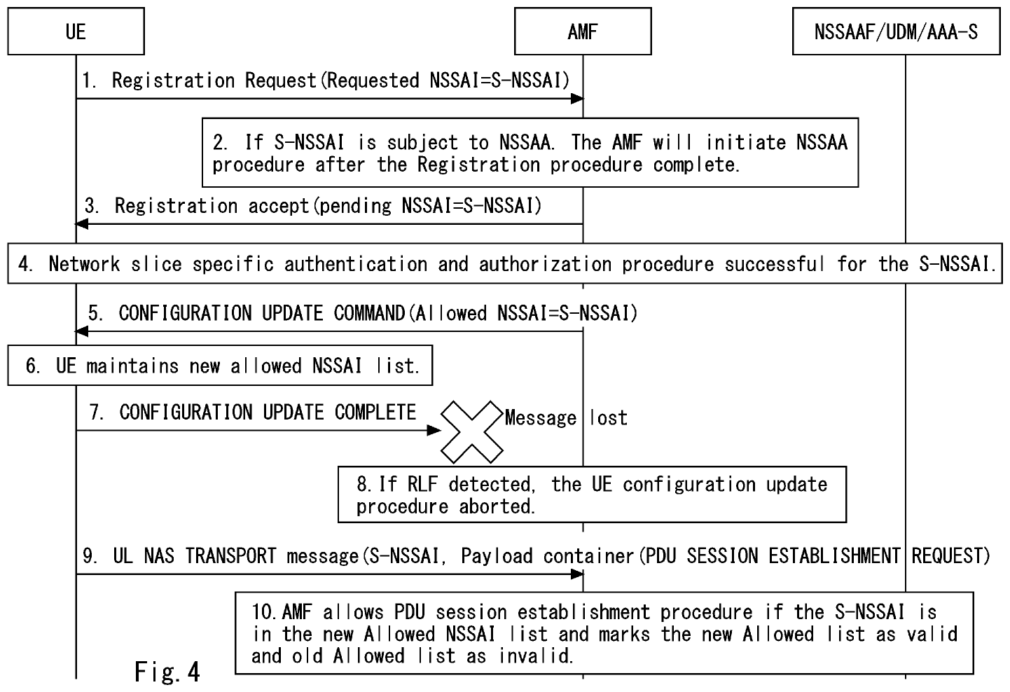

As shown in FIG. 4, when an AMF receives a request to activate a PDU session containing an S-NSSAI in the new Allowed NSSAI, the AMF shall allow the PDU session establishment procedure.

The details of this solution are mentioned below.

1. A UE sends, to an AMF, a REGISTRATION REQUEST message containing Requested NSSAI which includes at least one S-NSSAI.

2. When the AMF receives the REGISTRATION REQUEST message from the UE, the AMF determines whether the S-NSSAI included in the Requested NSSAI is subject to NSSAA or not by referring the subscriber data of the UE that is obtained from a UDM using the Nudm_SDM_Get service.

If the S-NSSAI is subject to NSSAA procedure, the AMF marks the S-NSSAI as pending.

3. The AMF sends, to the UE, a REGISTRATION ACCEPT message containing Pending NSSAI including the S-NSSAI.

4. The AMF initiates the NSSAA procedure for the S-NSSAI as described in the section 4.2.9 in 3GPP TS 23.502 [3]. This step 4 refers to only EAP based Network Slice-Specific Authentication and Authorization for S-NSSAI. The UE Configuration Update procedure that may execute after the EAP based Network Slice-Specific Authentication and Authorization is described in step 5 and later.

5. After the successful completion of the NSSAA procedure for the S-NSSAI, the AMF initiates generic UE configuration update procedure by sending a CONFIGURATION UPDATE COMMAND message containing a new Allowed NSSAI including the S-NSSAI. The AMF may start a retry timer (e.g. T3555) at the same time when the AMF sends the CONFIGURATION UPDATE COMMAND message or after the AMF sends the CONFIGURATION UPDATE COMMAND message. The AMF maintains (or stores) the new Allowed NSSAI and an old Allowed NSSAI. The old Allowed NSSAI does not include the S-NSSAI which is subject to the NSSAA procedure in step 4.

The AMF also may start the retry timer when the NSSAA procedure fails and the AMF sends the CONFIGURATION UPDATE COMMAND message containing Rejected NSSAI including the S-NSSAI. That is, a cause of start of the retry timer is a transmission of the CONFIGURATION UPDATE COMMAND message.

6. The UE updates the status of Allowed NSSAI or Rejected NSSAI based on the contents of the CONFIGURATION UPDATE COMMAND message. If the CONFIGURATION UPDATE COMMAND message includes the S-NSSAI in the Allowed NSSAI, it is interpreted by the UE that the S-NSSAI is available to use.

7. The UE sends the CONFIGURATION UPDATE COMPLETE message to the AMF. However, this message cannot be reached to the AMF due to a radio link failure.

8. When the AMF detects the radio link failure happened (e.g. the NG-RAN indicates to the AMF the UE radio contact is lost through a NGAP message), the AMF aborts the generic UE configuration update procedure and the retry timer is stopped if running.

9. The UE sends an UL NAS TRANSPORT message to the AMF to establish a PDU session. The UL NAS TRANSPORT message includes the S-NSSAI and the Payload container that contains a PDU SESSION ESTABLISHMENT REQUEST message.

The AMF receives the UL NAS TRANSPORT message. The AMF verifies or determines whether the S-NSSAI included in the UL NAS TRANSPORT message is present in the new Allowed NSSAI or not in the AMF. If the S-NSSAI is present in the new Allowed NSSAI, then the AMF allows establishment of the PDU session and transmits the PDU SESSION ESTABLISHMENT REQUEST message to the SMF and continues the PDU SESSION ESTABLISHMENT procedure as described in the 4.3.2 in 3GPP TS 23.502 [3].

The AMF marks (or stores, or maintains) the new Allowed NSSAI as valid and deletes the old allowed NSSAI. The AMF may forward the new Allowed NSSAI to the NG-RAN in an NGAP message. The AMF may also forward the new Allowed NSSAI to the SMF.

In one example, if the S-NSSAI is present in the new Allowed NSSAI but not present in the old Allowed NSSAI in the AMF, the AMF understands that the UE has received the last CONFIGURATION UPDATE COMMAND message and makes the new Allowed NSSAI as valid and deletes the old allowed NSSAI. The AMF from this point only maintains the new Allowed NSSAI.

In one example, the UE determines if the S-NSSAI is present in either new Allowed NSSAI or old NSSAI list or both, the AMF considers the S-NSSAI as allowed and transmits the PDU SESSION ESTABLISHMENT REQUEST message to the SMF.

### Fourth Example Embodiment (Solution 4)

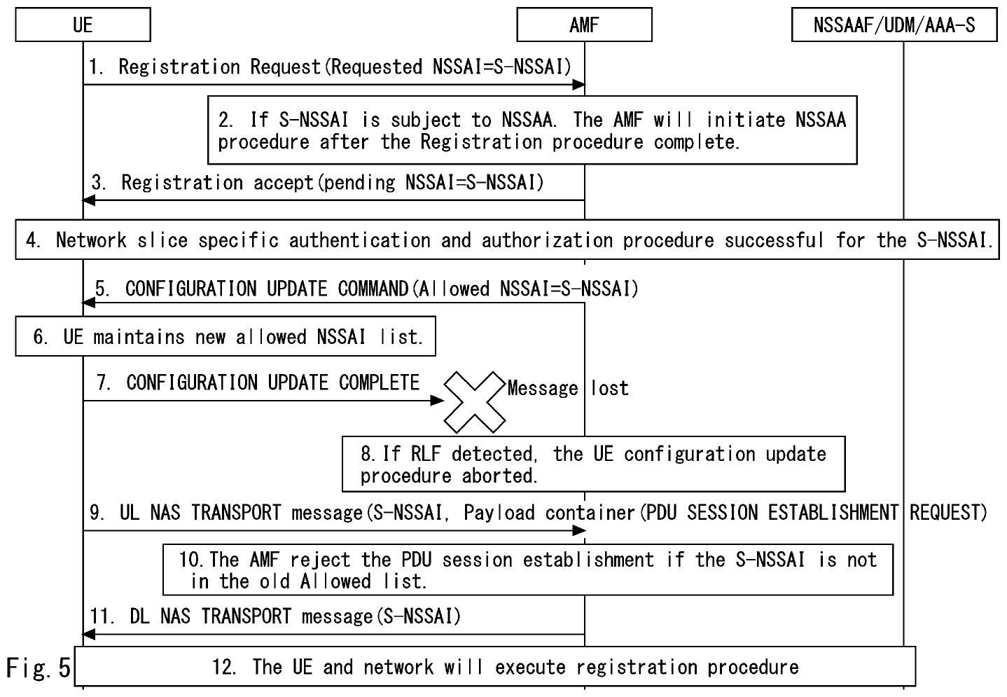

As shown in FIG. 5, when an AMF receives a request to activate a PDU session containing an S-NSSAI which is not in the old allowed NSSAI list, the AMF rejects the PDU session establishment procedure. Following this the UE initiates Registration procedure by sending a REGISTRATION REQUEST message containing the S-NSSAI in the Requested NSSAI list.

The details of this solution are mentioned below.

1. A UE sends, to an AMF, the REGISTRATION REQUEST message containing Requested NSSAI which includes at least one S-NSSAI.

2. When the AMF receives the REGISTRATION REQUEST message from the UE, the AMF determines whether the S-NSSAI included in the Requested NSSAI is subject to NSSAA or not by referring the subscriber data of the UE that is obtained from a UDM using the Nudm_SDM_Get service. If the S-NSSAI is subject to NSSAA procedure, the AMF marks the S-NSSAI as pending.

3. The AMF sends, to the UE, a REGISTRATION ACCEPT message containing Pending NSSAI which includes the S-NSSAI.

4. The AMF initiates the NSSAA procedure for the S-NSSAI as described in the section 4.2.9 in 3GPP TS 23.502 [3]. This step 4 refers to only EAP based Network Slice-Specific Authentication and Authorization for S-NSSAI. The UE Configuration Update procedure that may execute after the EAP based Network Slice-Specific Authentication and Authorization is described in step 5 and later.

5. After the successful completion of the NSSAA procedure for the S-NSSAI, the AMF initiates generic UE configuration update procedure by sending a CONFIGURATION UPDATE COMMAND message containing a new Allowed NSSAI which includes the S-NSSAI. The AMF may start a retry timer (e.g. T3555) at the same time when the AMF sends the CONFIGURATION UPDATE COMMAND message or after the AMF sends the CONFIGURATION UPDATE COMMAND message. The AMF maintains the new Allowed NSSAI and an old Allowed NSSAI.

The AMF also may start the retry timer when the NSSAA procedure fails and the AMF sends the CONFIGURATION UPDATE COMMAND message containing Rejected NSSAI which includes the S-NSSAI. That is, a cause of start of the retry timer is a transmission of the CONFIGURATION UPDATE COMMAND message.

6. The UE updates the status of Allowed NSSAI or Rejected NSSAI based on the contents of the CONFIGURATION UPDATE COMMAND message. If the CONFIGURATION UPDATE COMMAND message includes the S-NSSAI in the Allowed NSSAI, it is interpreted by the UE that the S-NSSAI is available to use.

7. The UE sends the CONFIGURATION UPDATE COMPLETE message to the AMF. However, this message cannot be reached to the AMF due to a radio link failure.

8. When the AMF detects the radio link failure happened (e.g. the NG-RAN indicates to the AMF the UE radio contact is lost through a NGAP message), the AMF aborts the generic UE configuration update procedure and the retry timer is stopped if running.

9. The UE sends an UL NAS TRANSPORT message to the AMF to establish a PDU session. The UL NAS TRANSPORT message includes the S-NSSAI and the Payload container that contains a PDU SESSION ESTABLISHMENT REQUEST message.

10. When the AMF receives UPLINK (UL) NAS TRANSPORT message containing the S-NSSAI and the S-NSSAI included in the UL NAS TRANSPORT message is not present in the old Allowed NSSAI in the AMF, the AMF rejects the UL NAS TRANSPORT message. That is, the AMF rejects establishment of the PDU session.

11. The AMF sends a DOWNLINK (DL) NAS TRANSPORT message to the UE indicating that the UPLINK (UL) NAS TRANSPORT message in step 10 is rejected by the AMF. This message may contain a new 5G MM cause “Unsynchronized S-NSSAI” or “Re-registration required due to Unsynchronized S-NSSAI” or “Network Specific Slice Authentication and Authorization procedure required” or any other cause value indicating to the UE that S-NSSAI status between the UE and the network may be mismatched and thus the registration procedure should be executed in order to be synchronized. When the UE receives the DOWNLINK (DL) NAS TRANSPORT message, the UE deletes the S-NSSAI from the Allowed NSSAI in the UE.

12. Based on the information in the DOWNLINK (DL) NAS TRANSPORT message, the UE may initiate Registration procedure by sending the REGISTRATION REQUEST message containing Requested NSSAI which may include the S-NSSAI.

If the AMF determines that the S-NSSAI in the Requested NSSAI is to be included in the new Allowed NSSAI in a REGISTRATION ACCEPT message, the AMF sends, to the UE, the REGISTRATION ACCEPT message containing a new and the new Allowed NSSAI which includes the S-NSSAI.

If the S-NSSAI in the Requested NSSAI is subject to the NSSAA procedure and the AMF decided to perform the NSSAA procedure for the S-NNSAI, then the UE and the network perform the NSSAA procedure for the S-NNSAI and the generic UE configuration update procedure. After completion of the NSSAA procedure and the generic UE configuration update procedure followed by the registration procedure, the Allowed NSSAI status is synchronized between the UE and the network and the AMF makes the new Allowed NSSAI as valid and the old Allowed NSSAI as invalid and uses new Allowed NSSAI in the subsequent NAS procedure or any other procedure.

The following bullets explain some examples for the details on the Allowed NSSAI status synchronization between the UE and the network.
(1) The UE makes the new Allowed NSSAI as valid and the old Allowed NSSAI as invalid after receiving the REGISTRATION ACCEPT message containing the new Allowed NSSAI which includes the S-NSSAI in response to the REGISTRATION REQUEST message.
(2) The UE makes the new Allowed NSSAI as valid and the old Allowed NSSAI as invalid after sending a REGISTRATION COMPLETE message to the AMF in response to the REGISTRATION ACCEPT message.
(3) The AMF makes the new Allowed NSSAI as valid and the old Allowed NSSAI as invalid after receiving the REGISTRATION COMPLETE message in response to the REGISTRATION ACCEPT message containing the new Allowed NSSAI which includes the S-NSSAI.
(4) The UE makes the new Allowed NSSAI as valid and the old Allowed NSSAI as invalid after receiving the CONFIGURATION UPDATE COMMAND message containing the new Allowed NSSAI which includes the S-NSSAI.
(5) The UE makes the new Allowed NSSAI as valid and the old Allowed NSSAI as invalid after sending the CONFIGURATION UPDATE COMPLETE message to the AMF in response to the CONFIGURATION UPDATE COMMAND message.
(6) The AMF makes the new Allowed NSSAI as valid and the old Allowed NSSAI as invalid after receiving a CONFIGURATION UPDATE COMPLETE message in response to the CONFIGURATION UPDATE COMMAND message containing the new Allowed NSSAI which includes the S-NSSAI.

In yet another embodiment, when the UE performs the registration procedure after the UE receives the DL NAS TRANSPORT message from the AMF, the AMF may inform, to UE, an S-NSSAI in the Allowed NSSAI, instead of putting it in the Pending NSSAI, if the previous NSSAA procedure in step 4 was successful.

Similar to the embodiment above, when the UE performs the registration procedure after the UE receives the DL NAS TRANSPORT message from the AMF, the AMF may inform to UE an S-NSSAI in the Rejected NSSAI, instead of putting it in the Pending NSSAI, if the previous NSSAA procedure in step 4 was failed to authenticate and authorize the S-NSSAI to use.

In an embodiment in step 5, the AMF may include a 5G-GUTI in the CONFIGURATION UPDATE COMMAND. If the network receives a 5G-GUTI which was sent in the CONFIGURATION UPDATE COMMAND message in a NAS message e.g. a SERVICE REQUEST message, the AMF makes the new Allowed NSSAI as valid and deletes the old Allowed NSSAI. The AMF will start using the new Allowed NSSAI in a subsequent NAS procedure or other UE related procedure.

Variant of the Solution 4:

When the AMF receives the UL NAS TRANSPORT message in step 9 and finds out that there might be a mismatch on S-NSSAI status between the UE and the Network, the AMF may initiate the NSSAA procedure for the S-NSSAI that is indicated in the UL NAS TRANSPORT message in step 9. Alternatively, the AMF may initiate the NSSAA procedure for all pending S-NSSAI, or all S-NSSAI in the MM context of the UE in the AMF.

After the NSSAA procedure, the UE sends the PDU Session establishment Request message containing S-NSSAI that has been successfully authenticated and authorized to use.

Variant for Each Embodiment:

If the UE moves to 5GMM-IDLE state (e.g. N1 signaling connection is released due to the radio link failure or RRC connection is released by the NG-RAN, or radio coverage lost) before the NSSAA procedure (step 4), during the NSSAA procedure (step 4) and during the UE Configuration Update procedure (step 5 to 8), the UE may initiate the Registration procedure or Service Request procedure or any other NAS procedure to establish the N1 NAS signaling connection so that the AMF can take an appropriate action to complete the NSSAA procedure. The following bullets explain an action to be taken by the AMF per period, when the UE moves to 5GMM-IDLE state.
(1) Period 1: The UE receives the Registration Accept message in step 3 but the NSSAA procedure in step 4 has not yet initiated.
(1-1) Action to be taken by the AMF when N1 NAS signaling connection has been established during the period 1: The AMF initiates the NSSAA procedure for all S-NSSAIs in the pending NSSAI.
(2) Period 2: During the NSSAA procedure in step 4.
(2-1) Action to be taken by the AMF when N1 NAS signaling connection has been established during the period 2: The AMF initiates the NSSAA procedure for all S-NSSAIs in the pending NSSAI or the AMF initiates the NSSAA procedure only for S-NSSAIs that the NSSAA procedure has not yet performed in the pending NSSAI.
(3) Period 3: After the NSSAA procedure in step 4 has completed but the generic UE configuration update procedure has not yet completed.
(3-1) Action to be taken by the AMF when N1 NAS signaling connection has been established during the period 3: The AMF initiates the generic UE configuration update procedure.

In case where the NSSAA procedure is performed after step 7 of FIG. 3 according to Variant to the solution 2, the above processes are applicable to the NSSAA procedure after step 7 of FIG. 3.

The present disclosure may be described as shown in section 5.4.4.6.

5.4.4.6 Abnormal Cases on the Network Side

The following abnormal cases can be identified:
a) Expiry of timer T3555.

The network shall, on the first expiry of the timer T3555, retransmit the CONFIGURATION UPDATE COMMAND message and shall reset and start timer T3555. This retransmission is repeated four times, i.e. on the fifth expiry of timer T3555, the procedure shall be aborted. In addition, if the CONFIGURATION UPDATE COMMAND message includes the 5G-GUTI IE, the network shall behave as described in case b)-1) below.

b) Lower layer failure.

If a lower layer failure is detected before the CONFIGURATION UPDATE COMPLETE message is received and:

1) if the CONFIGURATION UPDATE COMMAND message includes the 5G-GUTI IE, the old and the new 5G-GUTI shall be considered as valid until the old can be considered as invalid by the AMF. If a new TAI list was provided in the CONFIGURATION UPDATE COMMAND message, the old and new TAI list shall also be considered as valid until the old TAI list can be considered as invalid by the AMF.

During this period the AMF:

i) may first use the old 5G-S-TMSI from the old 5G-GUTI for paging within the area defined by the old TAI list for an implementation dependent number of paging attempts for network originated transactions. If a new TAI list was provided in the CONFIGURATION UPDATE COMMAND message, the new TAI list should also be used for paging. Upon response from the UE, the AMF may re-initiate the CONFIGURATION UPDATE COMMAND. If the response is received from a tracking area within the old and new TAI list, the network shall re-initiate the CONFIGURATION UPDATE COMMAND message. If no response is received to the paging attempts, the network may use the new 5G-S-TMSI from the new 5G-GUTI for paging for an implementation dependent number of paging attempts. In this case, if a new TAI list was provided with new 5G-GUTI in the CONFIGURATION UPDATE COMMAND message, the new TAI list shall be used instead of the old TAI list. Upon response from the UE the AMF shall consider the new 5G-GUTI as valid and the old 5G-GUTI as invalid.
ii) shall consider the new 5G-GUTI as valid if it is used by the UE and, additionally, the new TAI list as valid if it was provided with this 5G-GUTI in the CONFIGURATION UPDATE COMMAND message; and
iii) may use the identification procedure followed by a new generic UE configuration update procedure if the UE uses the old 5G-GUTI; or
2) if the CONFIGURATION UPDATE COMMAND message contains the Allowed NSSAI IE, then the AMF shall consider the new Allowed NSSAI IE as valid. When the AMF receives the UL NAS TRANSPORT message containing the S-NSSAI present in the new Allowed NSSAI, the AMF consider the S-NSSAI as allowed and take actions as specified in subclause 5.4.5.3. If the CONFIGURATION UPDATE COMMAND message does not include neither the IE nor the Allowed NSSAI IE, the network shall abort the procedure.
c) Generic UE configuration update and UE initiated de-registration procedure collision

If the network receives a DEREGISTRATION REQUEST message before the ongoing generic UE configuration update procedure has been completed, the network shall abort the generic UE configuration update procedure and shall progress the de-registration procedure.

d) Generic UE configuration update and registration procedure for mobility and periodic registration update collision

If the network receives a REGISTRATION REQUEST message before the ongoing generic UE configuration update procedure has been completed, the network shall abort the generic UE configuration update procedure and shall progress the registration procedure for mobility and periodic registration update procedure.

e) Generic UE configuration update and service request procedure collision

If the network receives a SERVICE REQUEST message before the ongoing generic UE configuration update procedure has been completed, both the procedures shall be progressed.

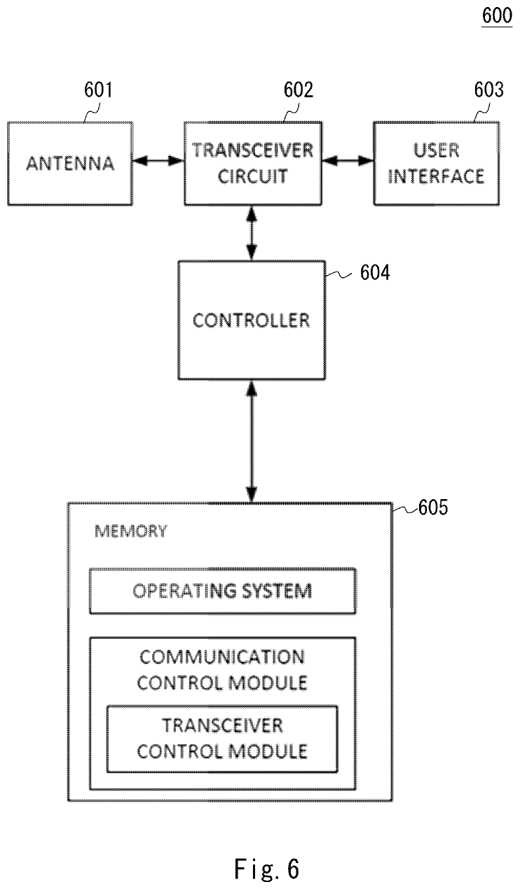

FIG. 6 is a block diagram illustrating the main components of the UE (600). As shown, the UE (600) includes a transceiver circuit (602) which is operable to transmit signals to and to receive signals from the connected node(s) via one or more antenna (601). Although not necessarily shown in FIG. 6, the UE will of course have all the usual functionality of a conventional mobile device (such as a user interface) and this may be provided by any one or any combination of hardware, software and firmware, as appropriate. Software may be pre-installed in the memory and/or may be downloaded via the telecommunication network or from a removable data storage device (RMD), for example.

A controller (604) controls the operation of the UE in accordance with software stored in a memory (605). The software includes, among other things, an operating system and a communications control module having at least a transceiver control module. The communications control module (using its transceiver control sub-module) is responsible for handling (generating/sending/receiving) signalling and uplink/downlink data packets between the UE and other nodes, such as the base station/(R)AN node, the MME, the AMF (and other core network nodes). Such signalling may include, for example, appropriately formatted signalling messages relating to connection establishment and maintenance (e.g. RRC connection establishment and other RRC messages), periodic location update related messages (e.g. tracking area update, paging area updates, location area update) etc. Such signalling may also include, for example, broadcast information (e.g. Master Information and System information) in a receiving case.

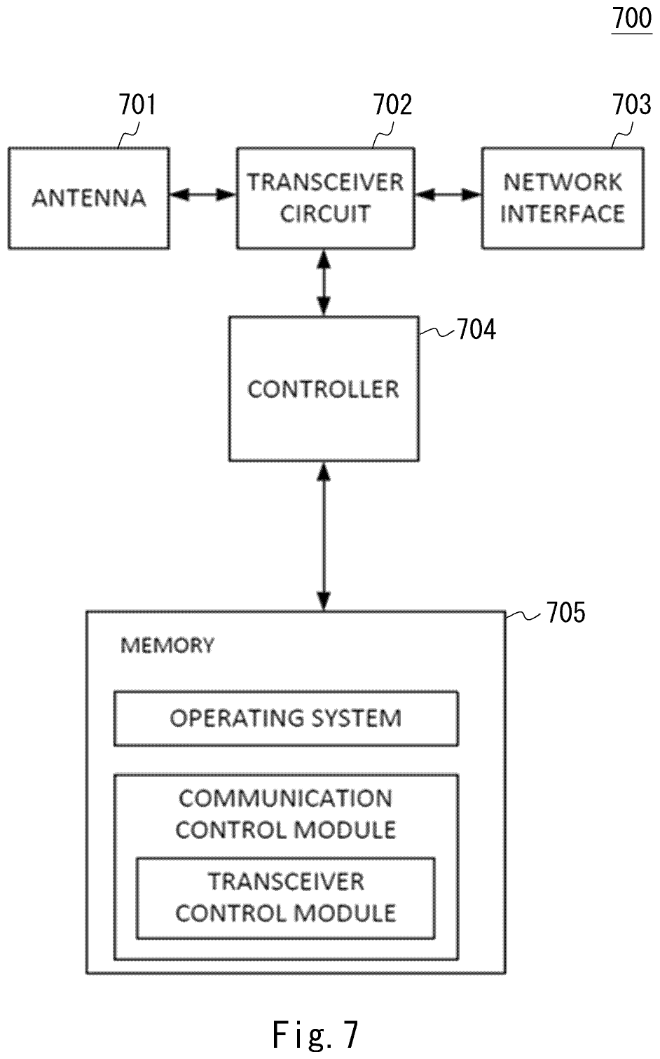

FIG. 7 is a block diagram illustrating the main components of an exemplary (R)AN node (700), for example a base station (‘eNB’ in LTE, ‘gNB’ in 5G). As shown, the (R)AN node includes a transceiver circuit (702) which is operable to transmit signals to and to receive signals from connected UE(s) via one or more antenna (701) and to transmit signals to and to receive signals from other network nodes (either directly or indirectly) via a network interface (703). A controller (704) controls the operation of the (R)AN node in accordance with software stored in a memory (705). Software may be pre-installed in the memory and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the (R)AN node and other nodes, such as the UE, the MME, the AMF (e.g. directly or indirectly). The signalling may include, for example, appropriately formatted signalling messages relating to a radio connection and location procedures (for a particular UE), and in particular, relating to connection establishment and maintenance (e.g. RRC connection establishment and other RRC messages), periodic location update related messages (e.g. tracking area update, paging area updates, location area update), S1 AP messages and NG AP messages (i.e. messages by N2 reference point), etc. Such signalling may also include, for example, broadcast information (e.g. Master Information and System information) in a sending case.

The controller (704) is also configured (by software or hardware) to handle related tasks such as, when implemented, UE mobility estimate and/or moving trajectory estimation.

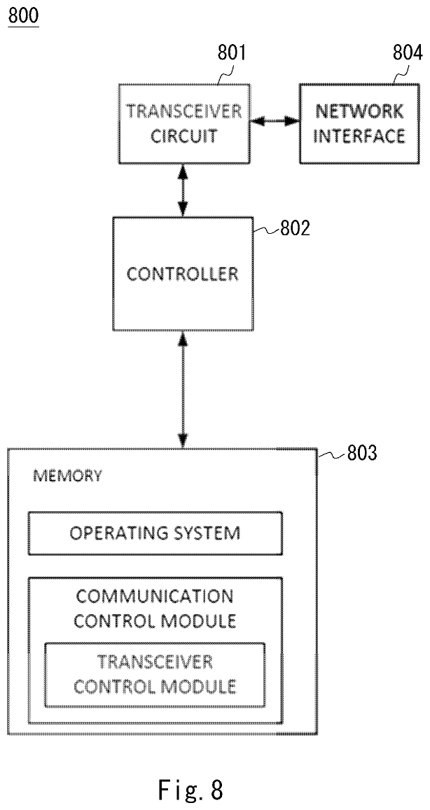

FIG. 8 is a block diagram illustrating the main components of the AMF (800). The AMF (800) is included in the 5GC. As shown, the AMF (800) includes a transceiver circuit (801) which is operable to transmit signals to and to receive signals from other nodes (including the UE) via a network interface (804). A controller (802) controls the operation of the AMF (800) in accordance with software stored in a memory (803). Software may be pre-installed in the memory (803) and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the AMF and other nodes, such as the UE, base station/(R)AN node (e.g. “gNB” or “eNB”) (directly or indirectly). Such signalling may include, for example, appropriately formatted signalling messages relating to the procedures described herein, for example, NG AP message (i.e. a message by N2 reference point) to convey an NAS message from and to the UE, etc.

The User Equipment (or “UE”, “mobile station”, “mobile device” or “wireless device”) in the present disclosure is an entity connected to a network via a wireless interface. It should be noted that the UE in this specification is not limited to a dedicated communication device, and can be applied to any device, having a communication function as a UE described in this specification, as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “UE” and “wireless device” also encompass devices that remain stationary for a long period of time.

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies. Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE may support one or more IoT or MTC applications. Some examples of MTC applications are listed in the Table 3 (source: 33GPP TS 22.368, Annex B, the contents of which are incorporated herein by reference). This list is not exhaustive and is intended to be indicative of some examples of machine type communication applications.

Table 1: Some examples of machine type communication applications.

TABLE 1
Some examples of machine-type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Further, a skilled programmer would be able to write such a computer program or identify the appropriate hardware circuits to implement the disclosed invention without difficulty based on the flow charts and associated description in the application text, for example. Therefore, disclosure of a particular set of program code instructions or detailed hardware devices is not considered necessary for an adequate understanding of how to make and use the invention. The inventive functionality of the claimed computer implemented processes will be explained in more detail in the following description in conjunction with the remaining figures illustrating other process flows. Further, certain steps in the processes or process flow described in all of the logic flow diagrams below must naturally precede others for the present disclosure to function as described. However, the present disclosure is not limited to the order of the steps described if such order or sequence does not alter the functionality of the present disclosure. That is, it is recognized that some steps may be performed before, after, or in parallel other steps without departing from the scope of the present disclosure.

Abbreviations

For the purposes of the present document, the abbreviations given in 3GPP TR 21.905 [1] and the following apply. An abbreviation defined in the present document takes precedence over the definition of the same abbreviation, if any, in
3GPP TR 21.905 [1].
5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
AF Application Function
AMF Access and Mobility Management Function
AS Access Stratum
ATSSS Access Traffic Steering, Switching, Splitting
ATSSS-LL ATSSS Low-Layer
AUSF Authentication Server Function
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCX Mission Critical Service
MDBV Maximum Data Burst Volume
MFBR Maximum Flow Bit Rate
MICO Mobile Initiated Connection Only
MPS Multimedia Priority Service
MPTCP Multi-Path TCP Protocol
N3IWF Non-3GPP InterWorking Function
N5CW Non-5G-Capable over WLAN
NAI Network Access Identifier
NEF Network Exposure Function
NF Network Function
NGAP Next Generation Application Protocol
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
W-SGAN Wireline 5G Access Network
W-SGBAN Wireline BBF Access Network
W-SGCAN Wireline 5G Cable Access Network
W-AGF Wireline Access Gateway Function

### Definitions

For the purposes of the present document, the terms and definitions given in 3GPP TR 21.905 [1] and the following apply. A term defined in the present document takes precedence over the definition of the same term, if any, in 3GPP TR 21.905 [1].

This application is based upon and claims the benefit of priority from Indian patent application No. 202011042823 filed on Oct. 1, 2020, the disclosure of which is incorporated herein in its entirety by reference.

### REFERENCE SIGNS LIST

600 UE
601 antenna
602 transceiver circuit
603 user interface
604 controller
605 memory
700 (R)AN node
701 antenna
702 transceiver circuit
703 network interface
704 controller
705 memory
800 AMF
801 transceiver circuit
802 controller
803 memory
804 network interface

What is claimed is:

1. A method of an Access and Mobility Management Function (AMF), the method comprising:
sending a CONFIGURATION UPDATE COMMAND message,
wherein the CONFIGURATION UPDATE COMMAND message includes Allowed Network Slice Selection Assistance Information (NSSAI) or Rejected NSSAI;
starting a timer in a case where the CONFIGURATION UPDATE COMMAND message is sent; and
retransmitting the CONFIGURATION UPDATE COMMAND message on expiry of the timer in a case where failure related to a radio link is detected before a CONFIGURATION UPDATE COMPLETE message is received.

2. A method of a User Equipment (UE), the method comprising:
communicating with an Access and Mobility Management Function (AMF); and
initiating a Registration procedure in a case where radio coverage is lost and the UE has Single Network Slice Selection Assistance Information (NSSAI) in Pending NSSAI.

3. An Access and Mobility Management Function (AMF) comprising:
at least one memory; and
at least one hardware processor coupled to the at least one memory,
wherein the at least one hardware processor is configured to:
send a CONFIGURATION UPDATE COMMAND message,
wherein the CONFIGURATION UPDATE COMMAND message includes Allowed Network Slice Selection Assistance Information (NSSAI) or Rejected NSSAI;
start a timer in a case where the CONFIGURATION UPDATE COMMAND message is sent; and
retransmit the CONFIGURATION UPDATE COMMAND message on expiry of the timer in a case where failure related to a radio link is detected before a CONFIGURATION UPDATE COMPLETE message is received.

4. A User Equipment (UE) comprising:
at least one memory; and
at least one hardware processor coupled to the at least one memory,
wherein the at least one hardware processor is configured to:
communicate with an Access and Mobility Management Function (AMF); and
initiate a Registration procedure in a case where radio coverage is lost and the UE has Single Network Slice Selection Assistance Information (NSSAI) in Pending NSSAI.
